(19) United States
(12) Patent Application Publication
(10) Pub. No.: US 2010/0217164 A1
(43) Pub. Date: Aug. 26, 2010

(54) CHAIR WITH MASSAGE UNIT AND REMOTE CONTROLLER

(75) Inventors: Elizabeth Harrison Meyer, Chicago, IL (US); Roman S. Ferber, West Bloomfield, MI (US); Mordechai Lev, West Bloomfield, MI (US); Hing Wah Tsang, Ajax (CA)

Correspondence Address: BROOKS KUSHMAN P.C., 1000 TOWN CENTER, TWENTY-SECOND FLOOR, SOUTHFIELD, MI, 48075, US

(73) Assignee: FKA DISTRIBUTING CO. D/B/A HOMEDICS, INC., Commerce Township, MI (US)

(21) Appl. No.: 12/676,446

(22) PCT Filed: Sep. 12, 2008
(86) PCT No.: PCT/US08/76144

§ 371 Date: May 10, 2010

Related U.S. Application Data
(60) Provisional application No. 60/971,682, filed on Sep. 12, 2007.

(51) Int. Cl. A61H 7/00; A47C 31/00

(52) U.S. Cl. 601/18; 297/217.3; 601/84

(57) ABSTRACT

A massage chair is provided with a base, a seat bottom, and a seat back having a peripheral frame. A peripheral cover is oriented over the frame. A central fabric cover is oriented within the peripheral cover and supported by the frame. A detachable massage unit is connected to the frame. A massager is provided with a seat back, a massage unit within the seat back, and a pair of armrests. A docking cavity is formed within one of the armrests and a remote controller is received within the docking cavity. A massager is provided with a body support member, a massage unit oriented in the body support member, a heater oriented in the body support member, and a wireless remote controller for controlling the operation of the massage unit and the heater by wireless signals.

### CROSS-REFERENCE TO RELATED APPLICATIONS

This application claims the benefit of U.S. provisional application Ser. No. 60/971,682 filed Sep. 12, 2007, which is incorporated in its entirety by reference herein.

### BRIEF DESCRIPTION OF THE DRAWINGS

FIG. 1 is a perspective view of a chair in accordance with the present invention;

FIG. 2 is a front elevation view of the chair of FIG. 1;

FIG. 3 is another perspective view of the chair of FIG. 1;

FIG. 4 is an enlarged perspective view of an armrest of the chair of FIG. 1;

FIG. 5 is a perspective view of a remote controller for the chair of FIG. 1;

FIG. 6 is a top plan view of the remote controller of FIG. 5; and

FIG. 7 is a side elevation view of the remote controller of FIG. 5.

### DETAILED DESCRIPTION OF EMBODIMENTS OF THE INVENTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

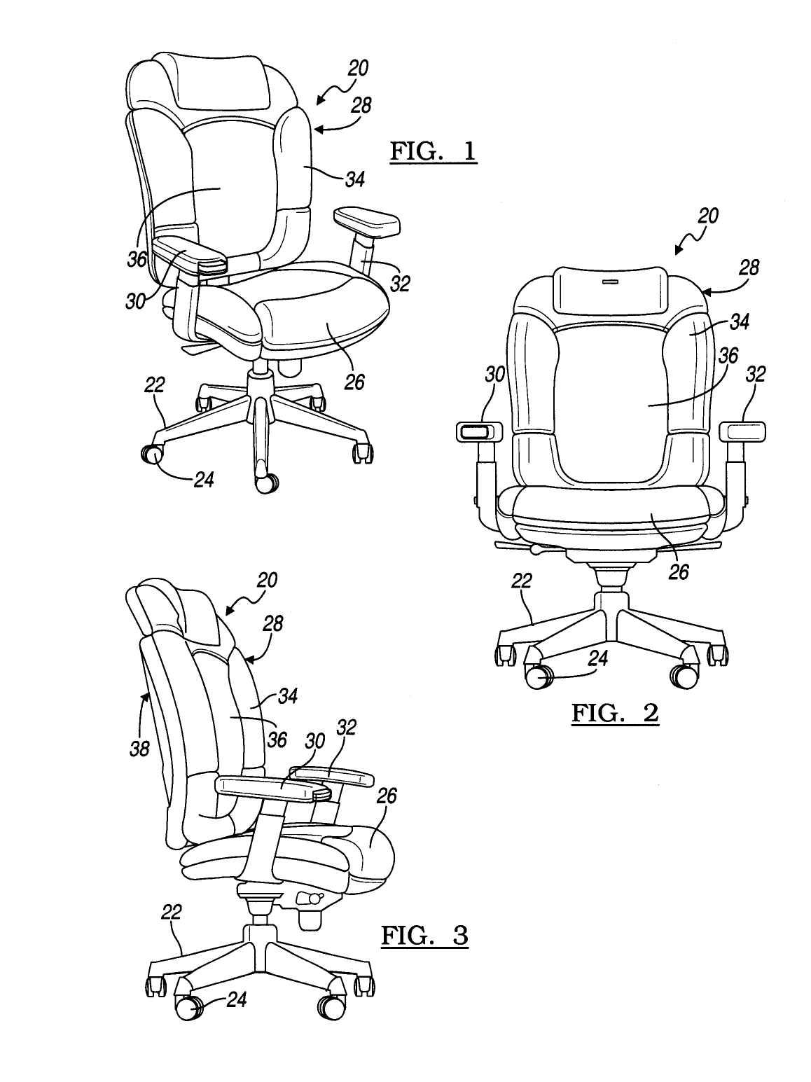

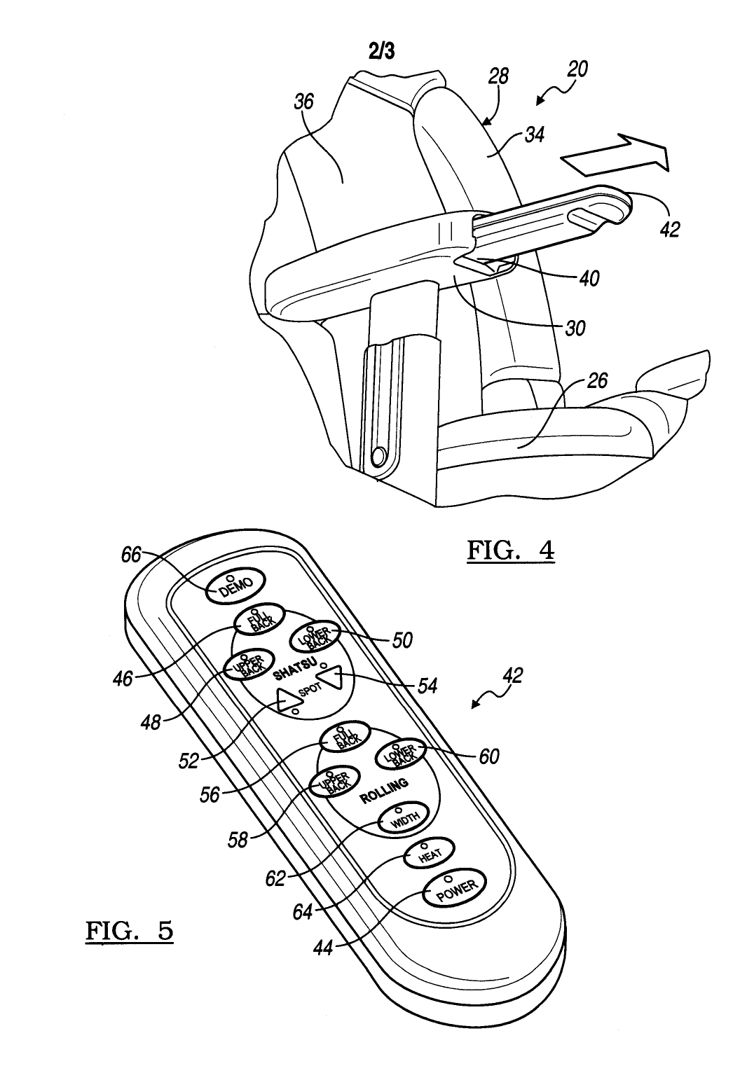

Referring now to FIGS. 1-3, a chair is illustrated in accordance with an embodiment of the present invention and is referenced generally by numeral 20. In at least one embodiment, the chair 20 is an office chair having a base 22 with casters 24 for supporting the chair 20 upon an underlying support surface, and for transporting the chair 20 upon the underlying support surface. The chair 20 has a seat bottom 26 that is mounted to the base 22 for seating and supporting a user. The seat bottom 26 may include a frame that is covered with cushioning, such as foam padding, and a cover.

A seat back 28 is mounted to the seat bottom 26 for receiving a back of the user and for supporting the back of the user. Similar to the seat bottom, the seat back 28 includes a frame that is covered by cushioning, which may be foam padding, and a cover.

The chair 20 also includes a pair of armrests 30, 32 that are each mounted to an underside of the seat bottom 26 and extend upward from lateral sides of the seat bottom 26 for receiving and supporting the arms of the user.

As is known in the art, each of the structural features of the chair 20 are adjustable. For example, the height of the seat bottom 26 is adjustable relative to the base 22; a resistance spring force upon the tilt connection between the seat bottom 26 and the base 22 is adjustable; a tilt angle of the seat back 28 relative to the seat bottom 26 is adjustable; and the height of the armrests 30, 32 relative to the seat bottom 26 are adjustable.

The seat back 28 includes a peripheral frame that is padded with cushioning and a cover 34. The cover 34 and underlying cushioning extend around the periphery of the seat back frame, which includes a lower pelvic region, side bolsters, and an upper shoulder and headrest region. The back rest 28 also includes a central fabric cover 36 mounted within the peripheral cover 34 and supported by the frame of the seat back 28. In one embodiment of the invention, the cover 36 is a mesh fabric that is mounted in tension to support the back of the user.

The seat back 28 includes a massage unit 38 that is mounted to a rear side of the seat back 28 and is connected to the frame. The massage unit 38 imparts a massage effect to the central cover 36 for massaging the back and shoulders of the user. The massage unit 38 is selectively detachable so that the user can utilize the chair 20 as a conventional office chair with or without the massage unit 38, or so that the user can utilize the chair 20 in combination with the massage unit 38 for seating the user and imparting the massage effect upon the back of the user. By providing the seat back 28 with a peripheral frame, and the central cover 36, the massage unit 38 can be selectively attached to the seat back 28 for providing the massage effect, or detached for providing a conventional seating configuration with the central cover 36 in tension for providing rear support. Alternatively, the massage unit 38 may be replaced with a structural blank, such as foam or padding to support the cover 36 from the rear.

Alternatively, multiple massage units 38 may be employed, each having a varying massage effect such that the user can remove one massage unit 38 and replace it with another massage unit 38. In addition, the detachability of the massage unit 38 provides ease and servicing and maintenance of the massage unit 38.

One such suitable massage unit is disclosed in Ferber et al. U.S. Patent Application Publ. 2007/0060851 A1, which published on Mar. 15, 2007 and is incorporated in its entirety by reference herein. The massage mechanism may be imparted directly to the underside of the central cover 36 so that the rollers provide rolling and kneading massage effects upon the back of the user.

Other known suitable massage units 38 can be utilized in combination with the chair 20 in accordance with the present invention such as rotary kneading massage units, hemispherical roller massage units, percussion (tapping) massage units, and any other suitable massage unit that can be contained within the massage unit such as massage unit 38 and installed into the seat back 28.

Referring now to FIG. 4, one of the armrests 30, has a docking cavity 40 formed therein for receiving a remote controller 42. As illustrated in FIGS. 1-3, the remote controller 42 is received within the cavity 40 of the armrest 30 to provide a generally flush and uniform appearance of the armrest 30. Referring again to FIG. 4, the user can deploy the controller 42 from the armrest 30 for operating the control features of the massage unit 38.

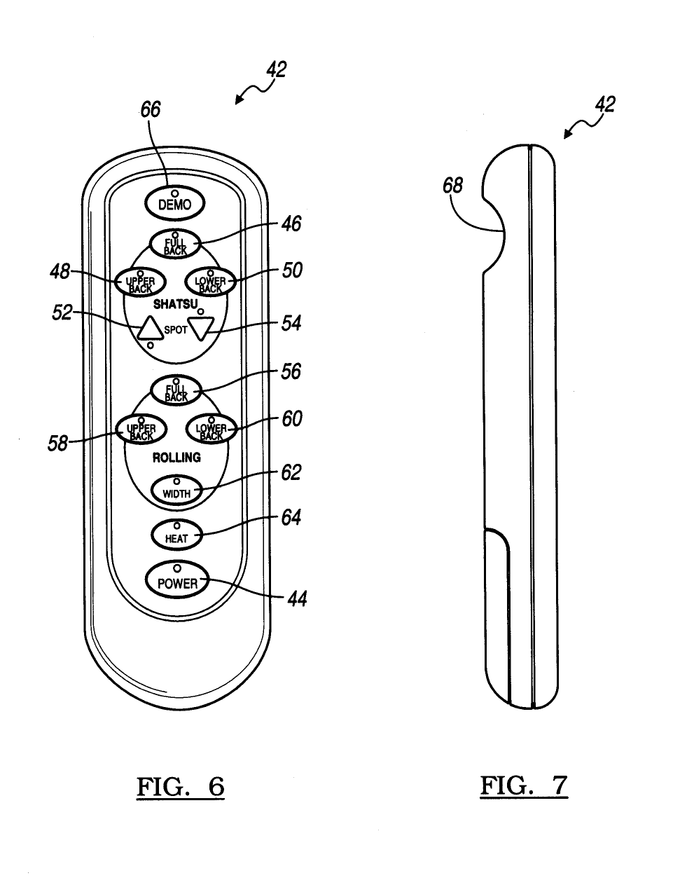

Referring now to FIGS. 5 and 6, the remote controller 42 is illustrated with functions that are associated with a suitable massage unit 38, such as the massage unit of the Ferber et al. U.S. 2007/0060851 A1 patent application publication. The remote controller 42 communicates with the massage unit 38 via wireless communication. Thus, the remote controller 42 transmits a wireless signal, such as a radio frequency signal from a radio frequency transmitter to a radio frequency receiver within the massage unit 38. Alternatively, the remote controller 42 can communicate with the massage unit 38 by infrared or any other suitable wireless communication. Although wireless communication is described, the invention contemplates that the remote controller could be hardwired and tethered to the chair 20 or directly to the massage unit 38. Wireless communication permits ease of use and interchangeability of the controller 42 and the massage unit 38.

The remote controller 42 includes a power button 44 for turning the massage unit 38 on and off. The remote controller 42 also includes controls for the kneading massage effect and the rolling massage effect provided from the massage unit 38. Each button on the remote controller 42 may include a light emitting diode (LED) for indicating that the associated function is in operation.

A full back shiatsu massage effect button 46 is provided for selecting a kneading and rolling massage effect to the full longitudinal range of the massage unit 38. An upper back shiatsu massage effect button 48 and a lower back shiatsu massage effect button 50 are also provided for controlling a kneading and rolling massage effect to a targeted range as defined by limits within the massage unit 38. The remote control 42 further includes an upward targeted kneading massage effect button 52 and a downward targeted kneading massage effect button 54 for providing the kneading massage effect to a targeted region upon the user's body.

A full back rolling massage effect button 56 is provided on the remote controller 42 for providing a full rolling massage effect from the massage unit 38. An upper back rolling massage effect button 58 and a lower back rolling massage effect button 60 are also provided for generating the rolling massage effect within a targeted range as set forth by limits within the massage unit 38. A width adjustment button 62 is also provided on the remote controller 42 so that while a user is experiencing a rolling massage effect, as selected by one of the rolling massage effect buttons 56, 58, 60, the user may adjust the width of the massage rollers.

In one embodiment of the invention, the remote controller 42 includes a heat button 64 for controlling a heating function of the massage unit 38. Of course, the invention contemplates utilization of massage units without heat. The remote controller 42 further includes a demo button 66 for providing a demonstration operation of various combination of the massage effects provided by the kneading and rolling buttons 46-62 so that the user experiences a variety of massage effects.

Referring now to FIG. 7, the remote controller 42 includes a finger well 68 formed in its underside to assist in removal from the armrest 30. Thus, the user can extend his or her fingers about the armrest 30 to the finger well 68 for pulling the remote controller 42 from the armrest cavity 40. In at least one embodiment, the remote controller 42 may cooperate with the armrest 30 through a latch mechanism such that the remote controller 42 must be unlatched before removal.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A massage chair comprising:
a base for resting upon an underlying support surface;
a seat bottom supported upon the base;
a seat back supported by at least one of the base and the seat bottom, the seat back having a peripheral frame;
a peripheral cover oriented over the peripheral frame of the seat back;
a central fabric cover oriented within the peripheral cover and supported by the peripheral frame; and
a detachable massage unit connected to the peripheral frame.

2. The massage chair of claim 1 wherein the central fabric cover is in tension for supporting a back of a user when the detachable massage unit is detached.

3. The massage chair of claim 1 further comprising a detachable structural blank that is adapted to be connected to the peripheral frame for removal of the detachable massage unit and installation of the detachable structural blank for supporting the central fabric cover from the rear.

4. The massage chair of claim 1 wherein the central fabric cover further comprises mesh.

5. The massage chair of claim 1 wherein the peripheral frame further comprises a lower pelvic region, a pair of side bolsters extending upward from the lower pelvic region, and an upper shoulder and headrest region extending across the pair of side bolsters.

6. The massage chair of claim 1 wherein the detachable massage unit is further defined as a first detachable massage unit; and
wherein the massage chair further comprises a second detachable massage unit that is adapted to be connected to the peripheral frame for removal of the first detachable massage unit and installation of the second detachable massage unit.

7. The massage chair of claim 6 wherein the second massage unit provides a massage effect that differs from that of the first massage unit.

8. The massage chair of claim 1 further comprising a pair of armrests for supporting arms of a user.

9. The massage chair of claim 8 wherein a docking cavity is formed within one of the armrests; and
wherein the massage chair further comprises a remote controller for controlling the operation of the massage unit, the remote controller being sized to be received within the docking cavity.

10. The massage chair of claim 9 wherein the remote controller is flush with the corresponding armrest in a docked position to provide a uniform appearance with that of the other armrest.

11. The massage chair of claim 9 wherein the remote controller is wireless and communicates with the massage unit by wireless signals.

12. The massage chair of claim 9 wherein the remote controller is provided with a finger well formed in the underside thereof to facilitate manual removal of the remote controller from the docking cavity.

13. A massager comprising:
a seat back;
a massage unit mounted within the seat back;
a pair of armrests for supporting arms of a user, wherein a docking cavity is formed within one of the armrests; and
a remote controller for controlling the operation of the massage unit, the remote controller being sized to be received within the docking cavity.

14. The massager of claim 13 wherein the remote controller is flush with the corresponding armrest in a docked position to provide a uniform appearance with that of the other armrest.

15. The massager of claim 13 wherein the remote controller is wireless and communicates with the massage unit by wireless signals.

16. The massager of claim 13 wherein the remote controller is provided with a finger well formed in the underside thereof to facilitate manual removal of the remote controller from the docking cavity.

17. The massager of claim 13 further comprising:
a base for resting upon an underlying support surface; and
a seat bottom supported upon the base;
wherein the seat back and the pair of armrests are each supported by at least one of the base and the seat bottom.

18. The massager of claim 13 further comprising a peripheral frame oriented within the seat back, wherein the massage unit has is detachably connected to the peripheral frame.

19. A massager comprising:
a body support member;
a massage unit oriented in the body support member;
a heater oriented in the body support member; and
a wireless remote controller for controlling the operation of the massage unit and the heater by wireless signals.

20. The massage chair of claim 19 wherein a docking cavity is formed within the body support member and is sized to receive the wireless remote controller.
